(19) United States
(12) Patent Application Publication
(10) Pub. No.: US 2011/0132887 A1
(43) Pub. Date: Jun. 9, 2011

(54) Vessel for Preparing and Cooking Food for a Household Electrical Appliance

(75) Inventor: Nicolas Valance, Dijon (FR)

(73) Assignee: SEB S.A., Ecully (FR)

(21) Appl. No.: 13/056,785

(22) PCT Filed: Jul. 30, 2009
(86) PCT No.: PCT/FR09/00957

§ 371 Date: Jan. 31, 2011

(30) Foreign Application Priority Data
Aug. 1, 2008 (FR) 08 04398

(51) Int. Cl. H05B 1/00; F27D 11/00

(52) U.S. Cl. 219/201; 219/385

(57) ABSTRACT

A vessel for preparing and cooking in a household electrical appliance includes a substantially horizontal bottom wall and one or more substantially vertical walls connected to the periphery of the bottom wall via a connecting wall, wherein the connecting wall has at least a radius of curvature greater than 30 mm.

The invention pertains to the category of devices for preparing and cooking food for a household electrical appliance, and specifically the vessel for cooking and preparing in these devices.

The bread maker is a well-known example of these devices which are capable of automatically and sequentially mixing various ingredients and then cooking the ingredients using radiation, conduction or convection energy.

The bread machine makes a wide variety of breads by kneading various types of dough, allowing them to rise and baking them according to the operator's preference and the broad range of ingredients used.

In general, the bread machine includes multiple functionalities, including the option to schedule bread making, alter cooking times, keep the bread warm after baking, etc.

Most of these devices have a rectangular vessel with a flat bottom wall, to which the device's fixed mixing blades are attached, as well as multiple vertical walls.

The various breads created in this way thus all have an elongated parallelepipedic shape molded by the vertical walls, which is sometimes difficult to unmold due not only to the vessel's significant height, but also to the presence of the mixing blades within the bread.

An example of such a bread machine can be seen in document JP 2008000255.

In addition, breads baked in this way have a significant amount of crust due to the shape of the container, which forces the dough to rise unnaturally between vertical walls and is not well suited to all types of bread.

The present invention is designed to eliminate disadvantages in prior art by offering a container with novel shapes designed to encourage the natural rising of the dough during fermentation, while making it easier to unmold the bread after baking.

This invention is achieved using a vessel for preparing and cooking food for a household appliance, comprised of a substantially horizontal bottom wall, as well as one or more substantially vertical walls attached to the periphery of the bottom wall by a connecting wall, characterized in that this connecting wall has a radius of curvature greater than 30 mm.

By offering a greater radius of curvature for the connecting wall, the vertical walls are somewhat distanced from the bottom wall, which positions the dough at the level of the bottom and connecting walls before the rising stage. The dough will thus have a tendency to rise naturally into a dome shape, without following the shape of the vertical walls, which minimizes the presence of vertical sides in the baked bread. Preferably, every radius of curvature in the connecting wall would be greater than 30 mm to avoid areas where the bread could potentially become stuck.

In addition, the removal of such bread is easier, since a significant part of the bread's outer crust is not attached to the walls of the vessel walls.

These advantages become more apparent as the radius increases. A connecting wall radius of curvature that is greater than 45 mm delivers significantly better results, since by comparison with normal vessel volumes for the ingredient quantities used, the bread no longer has vertical sides.

The effect is also increased if the connecting wall is substantially tangential to both the bottom wall and vertical wall(s).

The expression “tangential to” refers to the fact that the connecting wall is in the form of an arc that is essentially equivalent to a quarter of the circumference of a circle, such that it tangentially connects to the bottom wall as well as the vertical wall(s).

Thus, the curvature of the connecting wall is fully used, positioning the vertical walls as far away from the bottom wall as possible to encourage the natural rising of the bread by reducing the constraints imposed by the vertical walls.

Advantageously, the bottom wall of the vessel has at least one attachment place for an ingredient mixing blade.

This type of flared vessel design may result in the expulsion of ingredients during the initial mixing phase. The vertical walls may thus be extended to avoid this phenomenon. In this case, the vessel shall advantageously have many perforations along the upper portion of its periphery.

These openings allow air to circulate and, if the vessel is connected to radiant heating mechanisms, contribute to the penetration of infrared rays to brown the crust.

Advantageously, these perforations are circular, with a diameter of less than 10 mm, to allow the rays needed to color the bread to penetrate.

Advantageously, in accordance with a preferred version of the invention, the vessel is circular. This characteristic eliminates the four angular areas of elongated parallelepipedic vessels in which ingredients are retained during the dough mixing phase and which complicate the process of unmolding the bread.

In addition, the combination of a circular vessel and a significant radius of curvature of the connection wall between the bottom and vertical walls facilitates the dough's inward expansion during the rising process and yields a round loaf without a pronounced “wall” effect.

According to a specific embodiment of the invention, where [symbol] equals the diameter of the bottom wall, and [symbol] equals the diameter of the vessel as defined by the upper edge of its substantially vertical wall and [symbol] equals the height of the vessel as determined by the distance between the upper edge and the bottom wall the ratio [symbol] should be less than 0.9 and the ratio [symbol] should be greater than 1.

In other words, in this particular embodiment, this invention offers a new shape of vessel for preparing and cooking, specifically designed for the creation of bread products, with the following characteristics:

the vessel is circular, which results in round loaves without the angular areas in elongated parallelepipedic vessels that are prone to retaining ingredients during the mixing phase and impede the removal of the bread,

the vessel has an upper diameter that is substantially larger than the diameter of the bottom wall of the vessel, which allows for better air circulation and facilitates the removal of the bread,

the low height of the vessel compared to its upper diameter eliminates confinement of the dough resting at the bottom of the vessel, while increasing its exposure to the warm air flow.

Breads cooked in such a vessel thus have a properly browned and uniform crust, and a round loaf shape with a large crust surface.

Decreasing the ratio [symbol] by slanting the vertical walls, and/or increasing the distance between the connecting walls enhances the aforementioned advantages. Thus, it is preferable if the ratio [symbol] is less than 0.7.

Advantageously, to prevent the dough from spreading over the bottom wall, the diameter [symbol] of the bottom wall should measure at least 120 mm. This characteristic is important to prevent a loaf of bread weighing approximately 1 kg from being excessively shaped by the vessel's vertical walls.

The present invention also pertains to a household appliance containing a vessel for preparing and cooking in accordance with any of the preceding characteristics, including the means of enclosing the vessel in the device, the means of heating said vessel, and the means of moving the blade.

In one specific embodiment, the device is a bread maker.

Another application of the present invention is an oven containing a cooking chamber accessible via a door, with the oven containing means of enclosing the device in the chamber.

The present invention also applies to a food processor type of household appliance, containing a vessel for preparing and cooking in accordance with any of the preceding characteristics, with the device specifically containing at least one kneading blade for food inside the vessel, connected to a means of moving this blade as well as a means of heating the vessel.

Other characteristics and advantages of the invention shall be detailed in the following non-restrictive examples, which reference the attached figures.

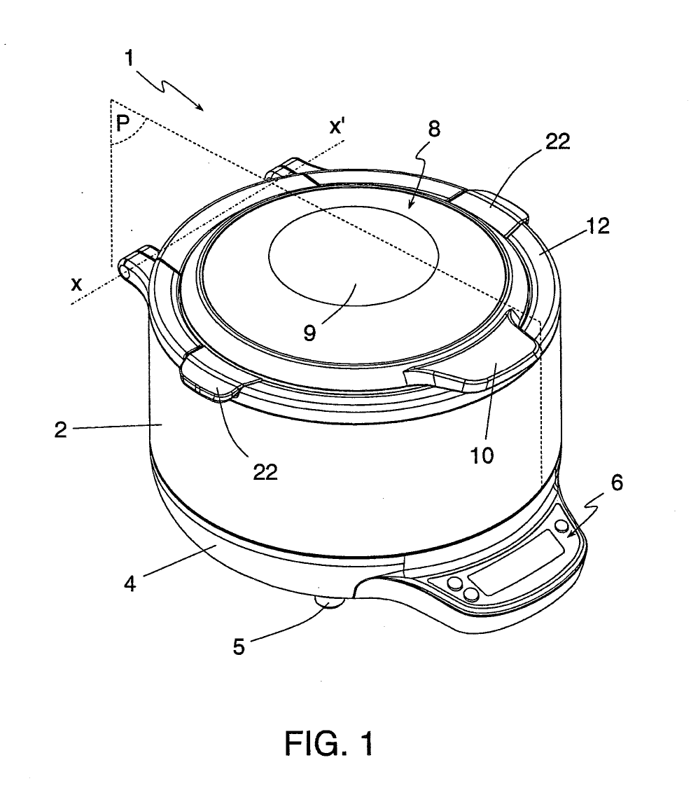

FIG. 1 depicts a perspective view of the invention as used in a bread machine.

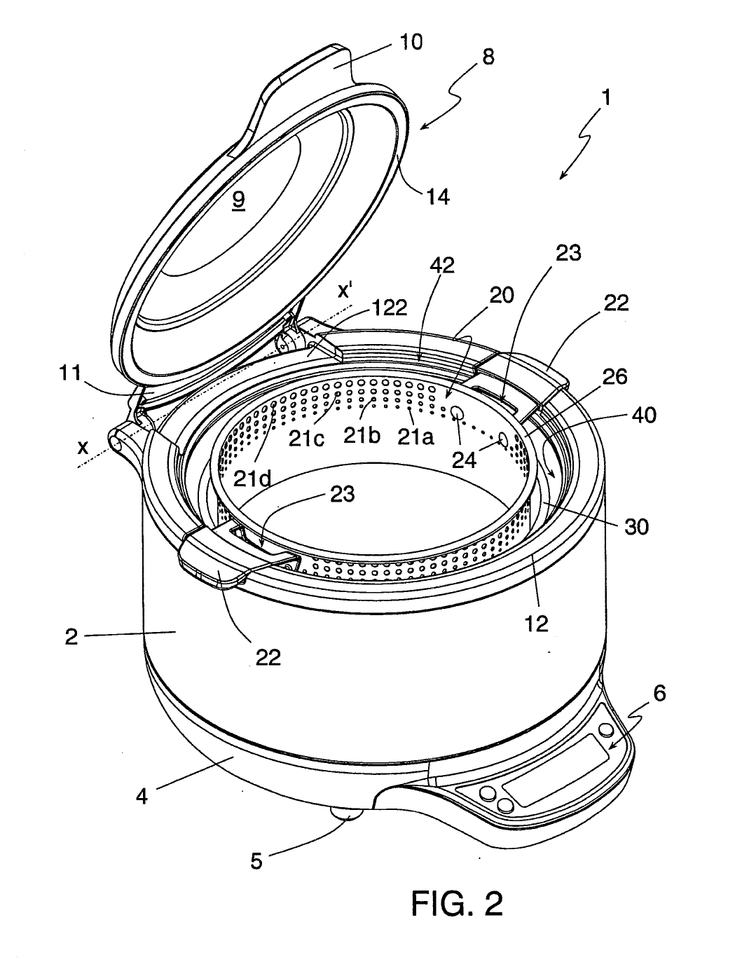

FIG. 2 depicts a view identical to that in FIG. 1, with the lid of the device open.

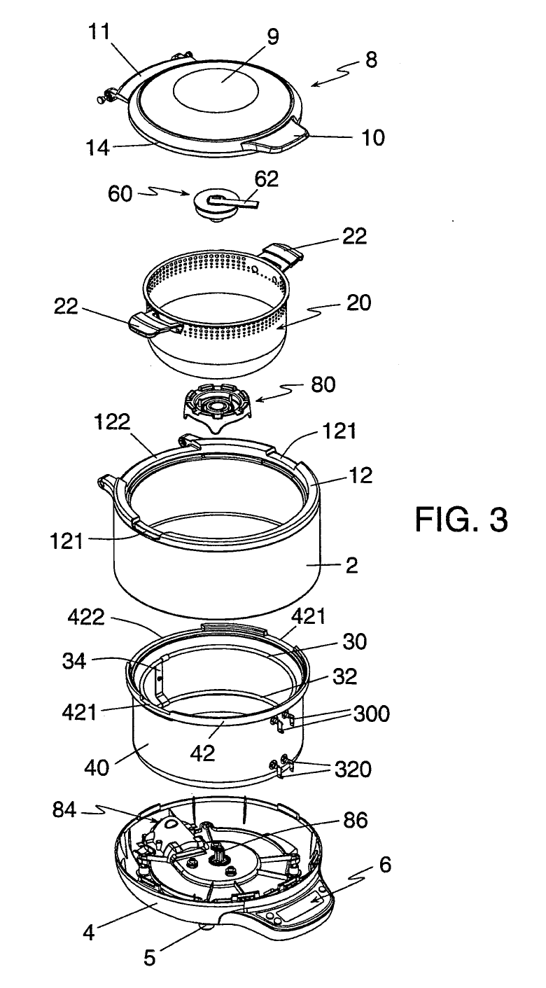

FIG. 3 depicts an exploded perspective view of the device.

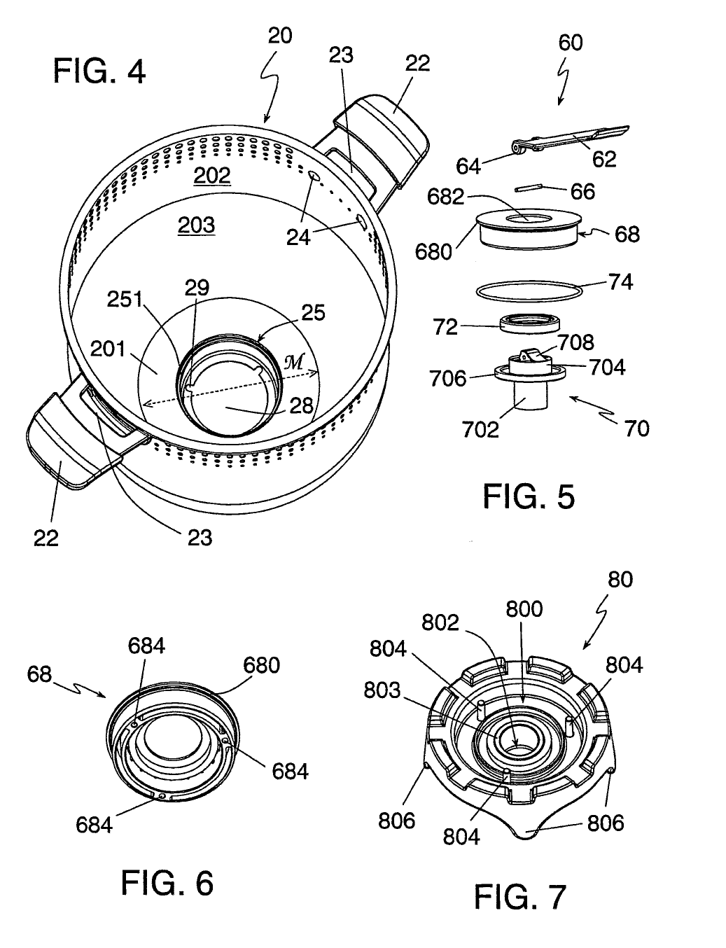

FIG. 4 depicts a front perspective view of the vessel that is the object of this invention.

FIG. 5 depicts an exploded front perspective view of an embodiment of the invention.

FIG. 6 depicts a rear perspective view of an embodiment of the invention.

FIG. 7 depicts a front perspective view of an embodiment of the invention.

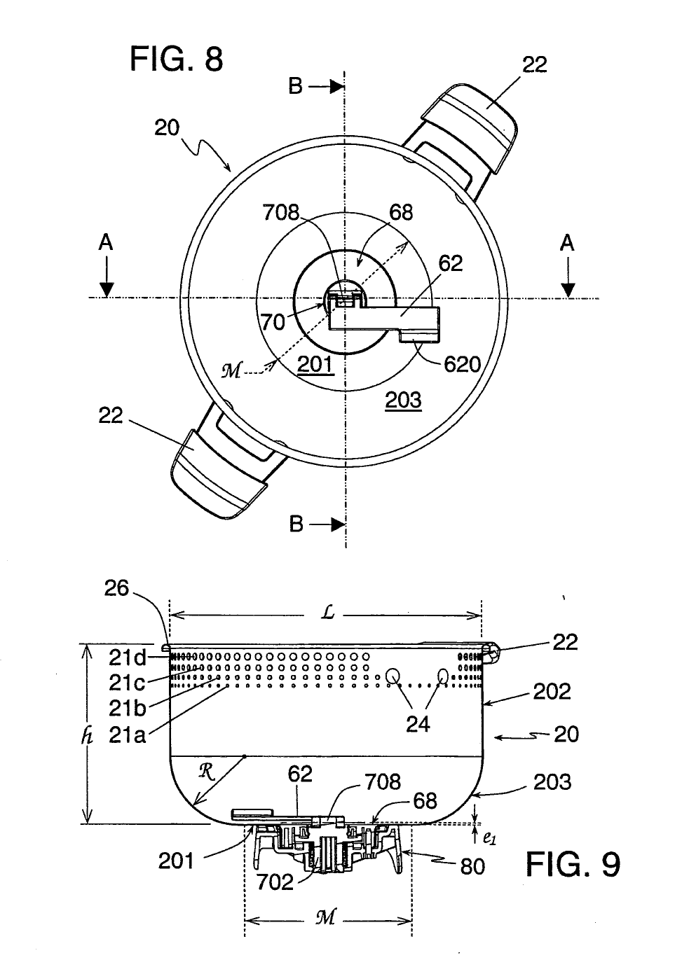

FIG. 8 depicts an aerial view of the vessel equipped with a mixing blade.

FIG. 9 depicts a cross-section along the A-A axis of FIG. 8.

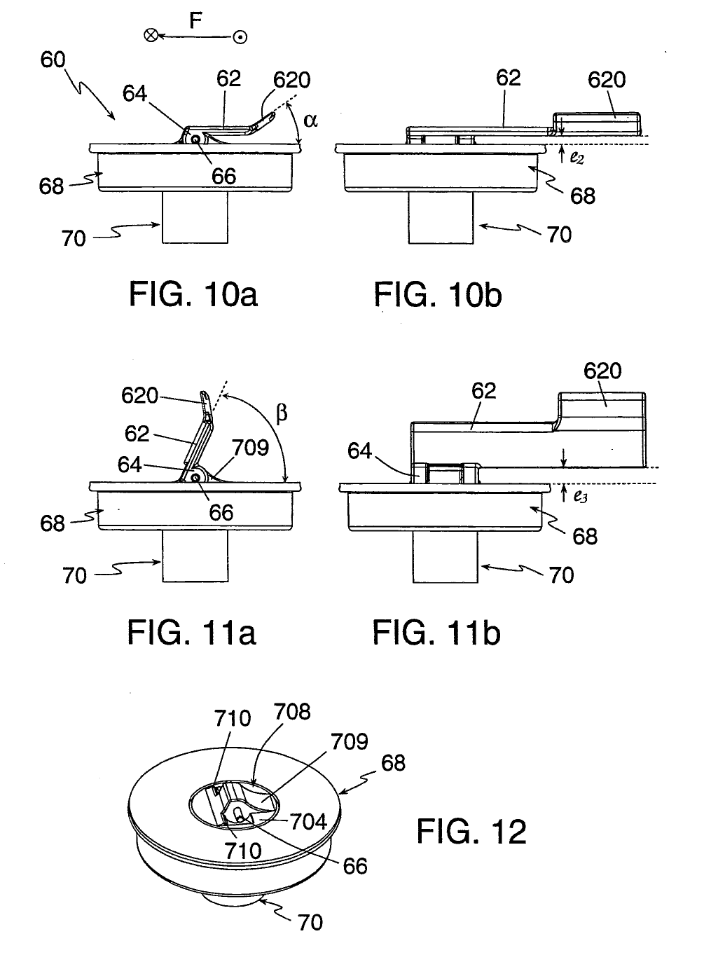

FIGS. 10a and 10b depict profile views, in different orientations, of the blade in an initial position.

FIGS. 11 a and 11 b depict the same views as those in FIGS. 10a and 10b, with the blade in a second position.

FIG. 12 depicts a front perspective view of the blade support in one example of an embodiment of the invention.

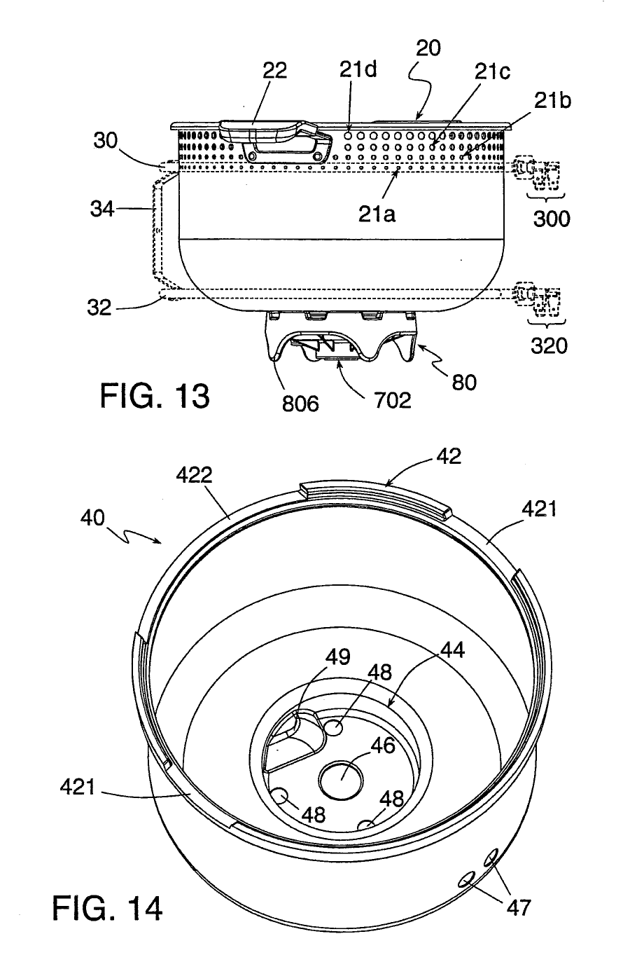

FIG. 13 depicts a profile view of the vessel, which includes other elements of its construction.

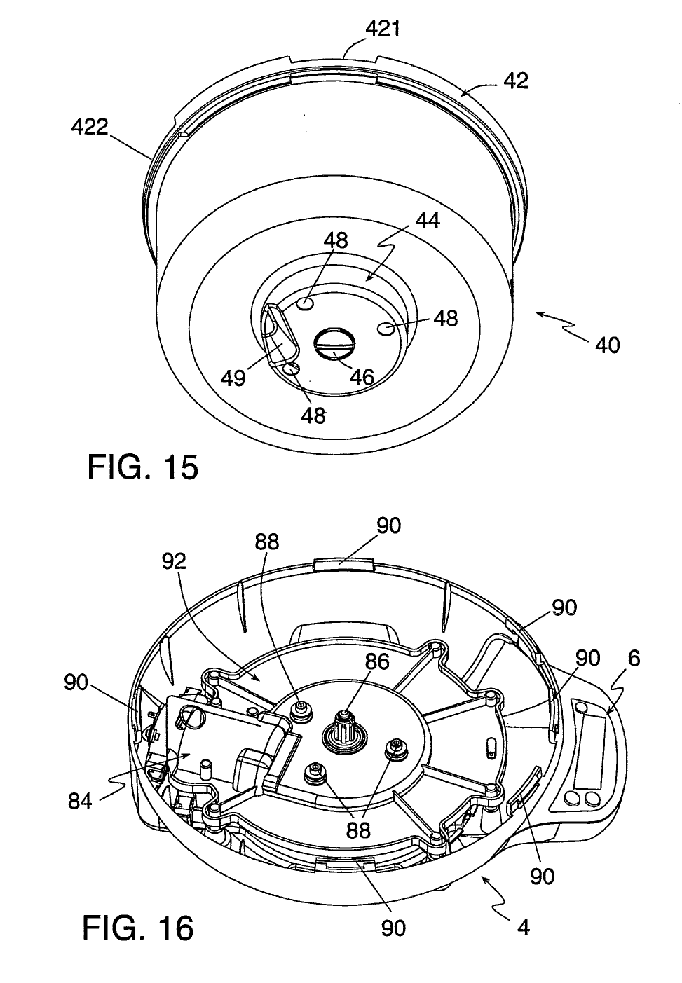

FIGS. 14 and 15 depict views of one element comprising the device, from a front perspective view and a rear perspective view, respectively.

FIG. 16 depicts a front perspective view of another element comprising the device.

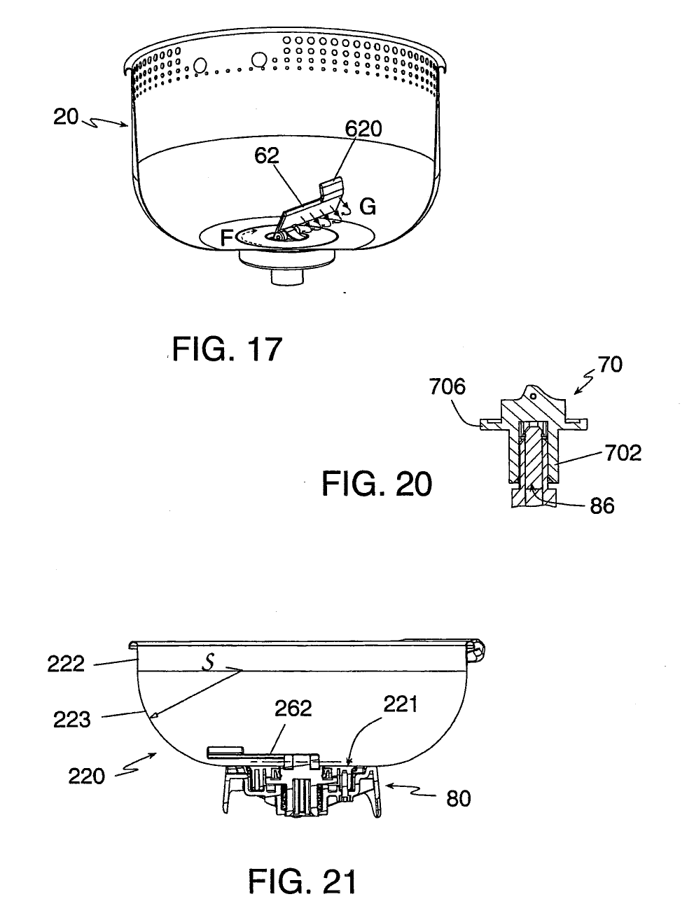

FIG. 17 depicts a truncated perspective view of the interior of the vessel equipped with a mixing blade.

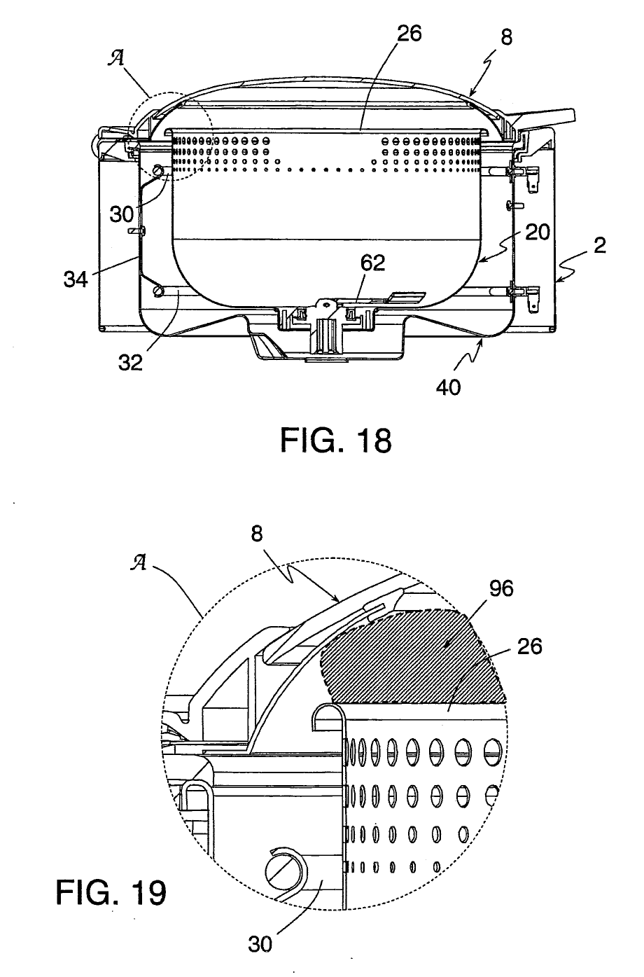

FIG. 18 depicts certain parts of the device in a cross-section view across Plane P of FIG. 1.

FIG. 19 depicts a larger view of element [symbol] from FIG. 18.

FIG. 20 depicts an embodiment in a cross-section along the S-S axis of FIG. 8.

FIG. 21 depicts a cross-section of an embodiment of a subassembly of the invention.

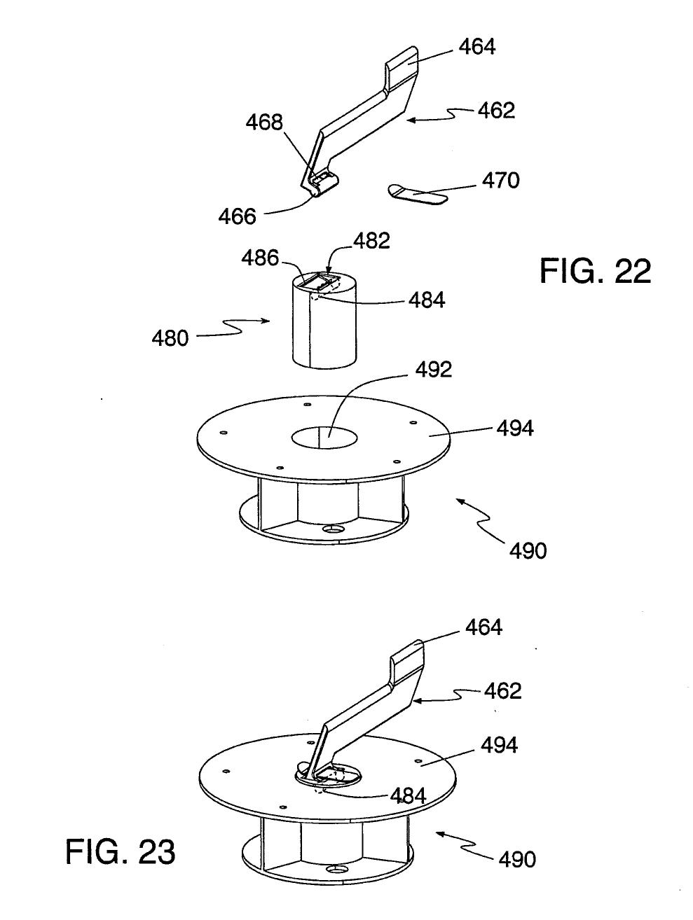

FIG. 22 depicts an exploded front perspective view of an embodiment of a subassembly of the invention.

FIG. 23 depicts an assembled view of the same subassembly depicted in FIG. 22.

FIGS. 1 through 3 depict a bread machine (1) with an outdated structure since the general form of the device is round. This bread maker (1) has an exterior wall (2) resting on a base (4) with feet (5), and the base is equipped with a user interface (6) comprised of a screen and buttons for adjusting the settings of the bread machine, as it is commonly known.

The device also has a cover (8) pivoting on axis x-x′, at the back of the device, with this axis being held and defined by a circular part (12), constituting a rim or ring located at the upper edge of the exterior wall (2).

The cover (8) has a handle (10) facilitating its pivoting on axis x-x′, and includes a transparent center part (9) for monitoring the bread making cycle.

The cover opening, as shown in FIG. 2, allows access to a circular vessel (20) for preparing and cooking that is fixed inside the device.

This vessel (20) includes handles (22) extending partially outside of the device when the cover is closed, as depicted in FIG. 1. These handles are attached to the vessel by any known means, such as rivets (24).

As depicted in FIGS. 2 and 4, the handles have a groove (23) to limit the transmission of heat to their extremities, and these grooves are covered in a silicone-type plastic.

In order to elegantly integrate the handles into the device, the circular part (12) contains recesses (121), depicted in FIG. 3, that partially accommodate the covered extremities of the handles, which are thus flush with the upper surface of this part (12), creating a certain continuity with the circular part (12).

In addition, these recesses, where the exterior covered parts of the handles are positioned, hold the vessel in place, preventing it from rotating when the blade is in operation. Their position, far from the center of the vessel, provides stability for the vessel during kneading.

Advantageously, this stability is improved by the size of these recesses and by the coefficient of friction obtained through the choice of material, in this case silicone, covering the vessel handles as these covered extremities are located in the recesses.

In addition, this part (12) includes a large rear recess (122), which along with part (11), forms a protrusion from the cover (8) that also includes elements pivoting around axis x-x′. This interaction between the parts guides the cover during rotation.

In addition, as clearly depicted in FIG. 1, the cover (8) has a convex shape as well as a diameter smaller than that of the circular edge piece (12). Thus the interaction between the recess (122) and the protrusion (11) allows the cover (8), and specifically its periphery edge (14), to be positioned within the space defined by the exterior wall (2).

According to one of the characteristics of the invention, the vessel (20) has a flat bottom wall (201), with diameter [symbol] a cylindrical vertical wall (202) terminating in an upper edge (26), and a curved connecting wall (203), connecting the bottom wall to the vertical wall, as specifically depicted in FIG. 4.

In addition, the vessel (20) has numerous perforations in the form of circular holes (21a through 21d), located on the upper part of the vessel under its edge (26).

Also depicted in FIG. 9, these holes are aligned vertically and positioned at different levels, with all holes at the same level having the same diameter. In addition, the holes increase in size as they approach the upper edge (26).

Thus, perforations 21a have a diameter of 2 mm, perforations 21b have a diameter of 3 mm, perforations 21c have a diameter of 4 mm and perforations 21d have a diameter of 5 mm. The role of these holes shall be explained below.

To avoid weakening the vessel's handle area, some holes were not created around the rivets (24).

As depicted in FIG. 3, the vessel is equipped with a kneading subassembly (60) with a blade (62) that is installed in the vessel, as well as a ring-shaped means (80) of attaching this subassembly (60) to the vessel.

The device also has an intermediary vessel (40) between the exterior wall (2) and the vessel (20) that contains an upper heating element (30) and a lower heating element (32). These heating elements are sheathed and are thus comprised of a metallic sheath in which a resistance heater wire is centered, surrounded by an electrically insulating magnesium material. Electrical current flowing through the wire increases the temperature of the wire and thus the metallic sheath. The heating elements (30), (32) are held in the intermediary vessel (40) by connection tips (300) and (320) and by an attachment (34) keeping the two elements a set distance apart, and attached to the intermediary vessel (40).

This intermediary vessel (40), like the vessel (20), has an upper ring (42) containing recesses (421) and (422), used for the same reason as recesses (121) and (122) in the circular part (12).

As depicted in FIG. 2, the ring (42) is located on the inside of circular part (12). In an alternate embodiment, the circular part (12) and the ring (42) are a single part.

The intermediary vessel (40) is preferably made of metal, and the upper ring (42) is advantageously made of a technical plastic able to withstand high temperatures.

Advantageously, this ring shall be made of a supple, silicone-type material in order to:

ensure that there is a watertight seal between the interior of the intermediary vessel (40) and the exterior wall (2) of the product to prevent burns;

ensure that there is a watertight seal between the interior of the intermediary vessel (40) and the cover (8) to prevent steam from escaping, creating a more confined cooking environment;

to absorb vibrations and reduce the noise created by the product during kneading. This ring is judiciously equipped with three silicone “silentbloc” bushings connected to the elements holding the intermediary vessel (40) in place.

Accordingly, this circular part may be made of a more updated and thus less onerous plastic material such as that which was used for the exterior wall (2).

Base (4), depicted in FIG. 3, contains a motor (84) driving a central pinion (86) connected to the blade, as will be explained hereinbelow.

FIGS. 4 through 9 depict the vessel (20) as well as the fixture of the blade and its support mechanism in said vessel. Thus, the bottom wall (201) of the vessel (20) has a sleeve (25) extending vertically toward the outside, with a central opening (28). This sleeve accommodates the kneading subassembly (60). This subassembly is depicted in FIG. 5. It is comprised of a substantially horizontal blade (62) mounted to rotate around a horizontal axle (66) located in a blade housing (64), with this axle also held by a part (708) of a blade supporting body (70).

This rotation axle allows the blade to be placed in several positions in the vessel.

In addition, the blade is also mounted for rotation around a central vertical axle defined by the body (70). This element also is comprised of a peripheral rim (706) as well as two cylindrical pieces located on each side of this rim, with a ring (704) holding the part (708), while another component (702) constitutes the base to initiate the blade's vertical rotation. A flexible seal (72) surrounds the ring (704), supporting the rim (706).

The kneading sub-assembly also includes a part (68) to hold the body (70), with this part (68) having a central opening (682) as well as a peripheral ridge defining a lip (680). The diameter of the part (68) is appropriate for the interior diameter of the sleeve (25).

With the seal (72) surrounding the ring (704), the body (70) is inserted into the part (708), and specifically into the axle (66), to extend slightly past the upper surface defined by the part (68).

In addition, the sleeve (25) has a slight recess (251) near the bottom wall (201) of the vessel, allowing the part (68) to be positioned in this recess, via an o-ring (74).

The seal of the vessel is thus provided by this ring (74) located by part (68) and by the ring (72) located by the blade.

The sub-assembly (60) is held on the vessel (20) by both the part (68) and the ring (80), with the vessel between these two elements.

Various known techniques such as soldering and riveting can be used. According to the proposed embodiment, the ring (80) includes three screws (804) located on a rim (800) that intersect with three recesses (29) in the sleeve (25), which rest in three corresponding niches (684) located on the lower wall of the part (68).

The ring (80) has a central opening (802) with a joint (803) acting as a bearing, and holding part (702) of the kneading subassembly, holding the blade (62).

The ring (80) also has four feet (806) to keep the vessel stable on a working surface after it has been removed from the device.

FIGS. 8 and 9 depict an aerial view and a cross-section along the A-A plane of the vessel with the kneading subassembly (60) installed, respectively.

As clearly depicted in these figures, the part (68) closes the bottom of the vessel flush with the bottom wall (201) such that no substantial recess is apparent in the bottom wall.

The location of the blade, essentially under the bottom wall of the vessel, minimizes its sticking in the bread, which facilitates removal of the bread while limiting the marks left by the blade in the bread.

According to one of the significant elements of the invention, the connecting wall (203) connecting the bottom wall (201) of the vessel to the vertical wall (202) is shaped in accordance with a radius of curvature [symbol] which has a value of around 50 mm. In addition, this connecting wall connects at a tangent to both the bottom wall and the vertical wall.

The height [symbol] the vessel is 130 mm, for a diameter [symbol] of 230 mm, such that the connecting wall extends over approximately 40% of the height of the vessel.

The diameter [symbol] of the bottom wall is 130 mm. In addition, the blade (62) extends radially, slightly above the bottom wall (201) as shown in FIG. 8. This figure also shows that at its free end the blade has an upper projection (620).

In addition, the blade's horizontal rotation axle is located slightly above the bottom wall. This slight inset of the blade of allows the rotation axle to be located at a distance e₁ separating it from the bottom wall by approximately 1 mm.

It is possible to further inset the blade by offering a rotation axle under the level of the bottom wall. With this rotation axle, the blade could have two positions in the vessel.

In addition, as shown in FIGS. 5 and 9, the connection between the blade and the central pinion (86) linked to the motor block (84) is located below the level of the vessel, unlike most bread machines, which minimizes the blade's protrusion beyond the bottom of the vessel and thus its imprint into the bread.

FIGS. 10 to 11 depict the kneading sub-assembly (60) according to the two blade positions. FIGS. 10a and 10b show the blade in the lower position, in profile and front views, respectively. FIGS. 11a and 11b are equivalent views of the blade in a higher position. These figures also show that the projection (620) on the blade (62) creates angle α with the flat part of the blade, angled up 35°.

As already described, the blade (62) has a horizontal rotation axle defined by the part (66), with the blade (62) including a housing (64) holding this part (66).

Thus, in the lower position, the blade (62) is located at a distance e₂ from the upper surface of the part (68), which also represents the bottom wall (201) of the vessel (20), with this distance e₂ being equal to 2 mm. In this position, the projection (620), is oriented according to angle α, with the blade being substantially horizontal.

FIG. 12 illustrates that the blade rotates freely from the lower position where the blade presses against an inclined portion (709) of the part (708), up to an upright position, where the housing (64) of the axle (66) presses against stops (710) that prevent it from pivoting any further.

Thus, the upright position corresponds to angle β of the blade (62), with the horizontal at 65°. In this position, space e₃ under the blade measures 5.5 mm.

Thus, according to an additional embodiment of the invention, the blade is fixed in the vessel (20) for preparing and cooking.

FIG. 13 depicts another aspect of the invention pertaining to perforations 21a through 21d of the vessel (20). This figure depicts the vessel (20) from the front, where the heating elements (30), (32) were drawn using dotted lines. It is thus clearly visible that the openings made in the vessel were substantially located at the level of the upper heating element (30), at least for the perforations (21a), located the furthest from the upper edge, to promote optimum cooking of the bread, as explained hereinbelow.

According to the embodiment of the device, this upper heating element may be slightly offset toward perforations (21b) or even (21c).

FIGS. 14 and 15 depict an aerial view and a perspective view from below, respectively, of the intermediary vessel (40), showing the openings (47) for the interior heating element (32) to pass through.

The central part of this vessel has an indentation (44) similar in function to the sleeve (25) of the vessel (20) that houses the vessel ring (80), which is guided by the walls of said indentation, the dimensions of which are suited to the size of the ring (80).

The indentation (44) also has a central opening (46), three small openings (48) distributed equilaterally, as well as a projection (49) directed toward the interior of the vessel.

FIG. 16 depicts the base (4) of the vessel, which specifically includes a motor block (84) as well as all of the electric and electronic circuits for the controls and display, all of which is covered by a protective enclosure (92). In the center of the base are three holding bodies (88) intersecting with the openings (48) in order to hold the intermediary vessel using riveting or an equivalent method. The central pinion (86), connected to the motor block starts from the base (4) and passes through the opening (46) in order to connect with the portion (702) of the kneading subassembly (6), which includes additional channels.

Clips (90) equally distributed along the periphery of the base (4) hold the exterior wall (2).

During use, the user puts various ingredients in the preparing vessel (20) which rests, via the ring (80) on a working surface, with this vessel permanently containing the blade (62), eliminating the possibility of forgetting to place said blade in the vessel since the blade is fixed, as is commonly-found in this type of device.

In this configuration the blade is lowered, either due to an initial placement in this position or by the action of the ingredients being put into the vessel.

The user then puts the vessel into the device after having opened the cover (8) with the indentation (44) receiving the ring (80) and the user ensuring that the covered handles are aligned with the recesses in the upper ring connected to the intermediary vessel.

In addition, as depicted in FIGS. 9, 16 and particularly FIG. 20, in this position, the central pinion (86) penetrates into the portion (702) at a considerably greater height than found in traditional bread machines, which, along with handles and guiding the ring (80) in the indentation (44), eliminates the need for the elements normally present on bread machines to hold the vessel in place or to remove it, such as clips or spring clips.

After selection, via the interface (6), of the various bread-making parameters, the first cycle begins, namely the mixing of the various ingredients.

The blade (62) is thus rotated in direction F, as shown in FIGS. 10a and 17, with the blade put into rotation by the central pinion (86), which is itself, put into rotation by the motor block (84).

With the blade in a lowered position before the start of the cycle, as illustrated in FIGS. 10a and 10b, the protrusion (620) and its tilt on the horizontal axis will allow the blade to rise up to the stops (710) shown in FIG. 12 when the blade (62) moves against the ingredients.

In this position, the blade is tilted at angle β at 65° above horizontal, which is an acute angle based on the direction of rotation of the blade. Thus, the ingredients are pushed toward the bottom of the vessel in accordance with direction G of FIG. 17, and a significant part of the ingredients pass through space e₃, such that the kneading phase is essentially conducted between the blade (62) and the bottom wall of the vessel, unlike traditional bread machines in which the kneading phase is conducted between the blade and the vertical walls of the vessel.

This vertical kneading movement is clearly visible as the blade rotates once the dough has been formed. In addition the significant radius of curvature of the connecting wall (203) encourages this vertical kneading movement, by more easily reincorporating the ingredients located near the connecting wall, with the end of the blade (62) extending slightly above the connecting wall.

When the kneading process is complete, the blade stops and is lowered back down by a slight rotation in the opposite direction, with the dough pushing the blade down in a horizontal direction.

Due to its slightly inset position and specifically because the blade does not substantially extend beyond the bottom wall of the vessel; the blade leaves only a thin layer of dough between itself and the bottom of the vessel. It is possible to reduce this layer of dough by increasing the inset of the blade, as already specified.

The heating elements then increase the temperature in the cooking chamber for baking. Perforations 21a through 21d, located at the level of the upper heating element (30), provide air circulation while allowing the surface of the bread to be colored by radiation.

It should be noted that the convex shape of the cover results in both good air circulation and additional space for the bread to rise and bake.

This characteristic is clearly seen in FIGS. 18 and 19, which offer a cross-section of plane P of FIG. 1 of the device minus its base and a magnified view of element A of FIG. 18, respectively.

These figures also illustrate that the cover closes below the upper edge (26) of the vessel, which prevents any ingredients from being expelled in the event that the vessel has a low height, as shown in FIG. 20.

In addition, this configuration creates an area of confinement, which can be judiciously used to prevent dough overflow during the rising and/or baking phases.

Indeed, in the event of overflow, any excess dough (96) will rapidly come into contact with the cover (8), which allows the excess dough to be contained right away. Later, this excess dough could raise the cover. A mechanism could thus be included to shut off the heating elements in the event that the cover opens, as described in patent application FR 08 02043. Dough overflow prevention or containment mechanisms, such as those described in patent applications FR 08 02042 and FR 08 02043 may be used in conjunction with this invention.

Advantageously, these mechanisms stop the blade when the cover is opened, which means the blade cannot be accessed when it is moving, to avoid the risk of injury.

Due to the configuration of the vessel, the bread rises and cooks “freely,” meaning that it is essentially formed by its consistency and the rising phases. The vertical wall (202), though essential to keep the ingredients together during mixing, is no longer useful after this stage, as afterwards the dough rests on the bottom wall (201) and part of the connecting wall (203). After the cooking is completed, the power supply to the heating elements is shut off and the device signals the end of cooking with a tone.

After having opened the cover (8), the user can then remove the vessel (20) from the device using the handles (22), which remain largely outside of the device and thus remain near room temperature, eliminating the risk of burns while removing the vessel from the device. This vessel may be set in a stable manner on a working surface on the ring (80).

Bread is removed from the vessel by turning over the vessel, since the shape of the vessel and specifically the connecting wall with its significant radius of curvature encourages the unmolding of the bread. The inset position of the blade also helps remove the bread and eliminates the presence of a deep mark in the bread.

The bread is thus in the form of a round loaf similar to that found at a bakery, since the bread is no longer “molded” by the walls of the vessel.

It thus appears that the creation of a round loaf, in which the effects of the vertical wall are barely visible or not visible on the bread, unlike molded breads from current machines, is also linked to the specific dimensions of the vessel for preparing and cooking. From testing conducted on circular vessels of different sizes, it has been found that a ratio between the diameter [symbol] and the height [symbol] of at least 1 results in the creation of homogenous breads with a well-browned crust.

Preferably, diameter [symbol] of the bottom wall (201) should be significantly smaller than diameter [symbol] of the vessel measured at the top, the [symbol] ratio in the example proposed being less than 0.7 and the resulting flared shape making it easy to remove the bread after baking. A ratio between 0.7 and 0.9 has a desirable effect on the shape of the bread.

This characteristic should be taken in consideration along with the curvature of the connecting wall (203), as previously described.

However, to be able to make the normal quantities of bread for this type of device, it is useful to make a vessel in which the bottom wall has a diameter greater than 120 mm, since an excessively small diameter results in the expansion of the dough up the vertical walls and a more molded type of bread making.

In fact, it appears that the 120 mm diameter is well suited for most 500 g to 1 kg breads. For other amounts of bread or different bread making techniques, the dimensions must be adjusted to find a balance between the utility of the vertical wall for the mixing stage and the need for it to avoid coming into contact with the bread during the rising and baking stages.

FIG. 21 depicts an embodiment in which the vessel (220) has a bottom wall (221) and a very large connecting wall (223) with a radius of curvature S of 75 mm, with a low vertical wall (222) measuring 30 mm. The diameter of the vessel is approximately 270 mm.

The ring (80) may be similar to that previously described. The blade may be slightly different, due to the significant curve of the connecting wall. The blade (262) is thus slightly smaller than that previously described, and slightly higher, so as not to be too close to the connecting wall (223). It still has a significant underlying space when it is raised back up, as previously explained.

The low height of the vessel eliminates the need for holes at the top of the vessel. However, in order to limit ingredient overflow during the mixing phase, slower blade rotation may be specified for this phase and/or a seal may be used between the device cover and the vessel.

The highly flared vessel shape, facilitating removal of the bread after baking, means that the blade may remain attached to the vessel while removing the bread, though advantageously the blade can be retracted from the bottom of the vessel, as previously described.

However, the blade may be removable from the device, by making the horizontal rotation connection removable at axle 66, for example, or by using a spring latch. FIGS. 22 and 23 illustrate such an example, in which the blade is also further inset into the vessel, facilitating the cleaning of the vessel and the blade.

As such, a blade (462) with a projection (464), with a similar shape to the previously described blade (62) has a full rotation axle (466) connecting to the housing (484) of a support part (480), with the housing located in the bottom of a cavity (482) in the surface of the part (480).

The blade has a hole (468) slightly above the axle (466), through which a spring latch (470) passes, fitting into appropriate recesses in the part (480), such as the recess (486), in order to keep the blade on the support part (480).

This support part is permanently attached in a housing (492) on a holding plate (490) with a flat upper surface (494) and structure substantially similar to part (68), with this upper surface partially constituting the bottom wall of the vessel.

As for the sub-assembly (60), seals are judiciously used to provide a tight seal for the assembly.

FIG. 23 depicts the various assembled elements. It is clearly visible that the rotation axle for the blade is located under the upper surface (494) of the plate (490), which forms the bottom of the vessel, which allows the blade to be lowered substantially onto the surface (494).

Stops in the cavity (482) allow the blade to be positioned higher, as depicted.

To remove the blade, the user releases the spring latch (470) from its housing and removes the blade, leaving the bottom of the vessel relatively flat with the exception of the cavity (482).

The present invention is not limited to the embodiments and modifications described and comprises numerous alternate embodiments.

Specifically, angle β of the blade, which pushes the dough toward the bottom of the vessel, may be between 40° and 85° to allow the dough to be rolled between the blade and the bottom of the vessel.

Angle α may also vary slightly, the principle being to make it possible to lift the blade after it comes in contact with the ingredients after said blade is rotated in reverse.

Space e₃ must be sufficiently sized to permit dough rolling without being so large that the process is not effective. Values of between 5 and 15 mm result in proper dough rolling.

In addition, perforations (21a) to (21d), present in vessels that require vertical walls high enough to avoid the projection of ingredients during the mixing phase, may be replaced by a circular shield on the upper part of a vessel with lower walls, as depicted in FIG. 21. In addition, advantageously, a water compartment or separate steam-producing compartment can be used to generate steam inside the device.

An effect similar to that obtained with a water compartment can be obtained by sufficiently sealing the cooking chamber. The steam produced by the bread itself thus saturates the cooking chamber and improves the end quality of some breads.

Although the round vessel is a key element of the invention, the invention is not limited to this specific shape of vessel and more oval or elliptical shapes may be used that include flat wall elements.

There may thus be several blades, judiciously located for satisfactory mixing of the ingredients and the dough.

Advantageously, the interior of the vessel and/or the blade may be coated with a material that facilitates cleaning, such as PTFE, which also facilitates the removal of the bread.

In addition, the blade may, as in current machines, have a removable attachment at the vertical turning axle. This configuration facilitates the removal of the bread since the blade is pulled by the bread during the unmolding process. Ideally, this removable attachment is located below the bottom of the vessel to reduce the mark made by the blade in the bread.

Finally the heating elements may be different that those described. Quartz heating elements may also be used. As a variation, it is possible to use flat film heating elements located on the vessel's exterior wall.

The scope of the present invention also includes embodiments in which the heating device is located outside of the vessel housing, with a fan and an air distribution duct circulating hot air in the vessel. Although the embodiment used depicts a bread maker, the present invention is not limited to this type of device. It may be applied to food processors that have a bowl within which a blade rotates to mix or knead dough. Some food processers offer mechanisms for heating the preparing bowl, thus encompassing some of the characteristics of the bread machine.

The present invention can also apply to an electric oven, with the vessel located in the cooking chamber and the means of turning the blade located in the deck of the oven, which could also include mechanisms for holding the vessel. The heating elements could be those of the oven.

1. A vessel for preparing and cooking in a household electrical appliance, comprising a substantially horizontal bottom wall and one or more substantially vertical walls connected to the periphery of the bottom wall via a connecting wall, wherein the connecting wall has a radius of curvature of at least 30 mm.

2. The vessel described in claim 1, wherein the radius of curvature of the connecting wall is greater than 45 mm.

3. The vessel described in claim 1, wherein all radii of curvature of the connecting wall are greater than 30 mm.

4. The vessel described in claim 1, wherein the connecting wall is substantially tangent to the bottom wall as well as to the vertical wall(s).

5. The vessel described in claim 1, wherein the bottom wall contains at least one space for housing a mixing blade.

6. The vessel described in claim 1, wherein said vessel has a plurality of perforations at its edge, with these perforations located on an upper part of the vessel.

7. The vessel described in claim 1, wherein the perforations are circular and have a diameter of less than 10 mm.

8. The vessel described in claim 1, wherein the vessel is circular.

9. The vessel described in claim 8, wherein a ratio M/L is less than 0.9 and that a ratio L/h is greater than 1, where M corresponds to a diameter of the bottom wall, L corresponds to a diameter of the vessel at an upper edge of the substantially vertical wall, and h corresponds to a height of the vessel defined by a distance between the upper edge and the bottom wall.

10. The vessel described in claim 9, wherein the ratio M/L is less than 0.7.

11. The vessel described in claim 9, wherein the diameter M of the bottom wall is at least 120 mm.

12. A household appliance containing a vessel for preparing and cooking described in claim 5, wherein the appliance includes a means for securing the vessel in the appliance, a means of heating the vessel and a means for moving the mixing blade.

13. The household appliance described in claim 12, wherein the appliance is an oven containing a cooking chamber accessible via a door, with the oven containing the means of securing the vessel in the chamber.

14. The household appliance described in claim 12, wherein the appliance is a bread maker.

15. The household electrical appliance containing a vessel for preparing and cooking described in claim 1, wherein the appliance is a food processor, specifically including at least a blade for mixing ingredients in the vessel connected to a means for moving the blade, as well as a means for heating the vessel for preparing and cooking.
